(19) United States
(12) Patent Application Publication
(10) Pub. No.: US 2007/0228720 A1
(43) Pub. Date: Oct. 4, 2007

(54) Retail shelf edge label media sheet

(75) Inventors: Andre M. Saint, Getzville, NY (US); Blaine Jackson, East Aurora, NY (US); Anne M. Dehlinger, Willimasville, NY (US)

Correspondence Address: CASELLA & HESPOS, 274 MADISON AVENUE, NEW YORK, NY, 10016, US

(73) Assignee: Avery Dennison Corporation, Pasadena, CA (US)

(21) Appl. No.: 11/731,919

(22) Filed: Apr. 2, 2007

Related U.S. Application Data
(60) Provisional application No. 60/789,195, filed on Apr. 3, 2006.
(60) Provisional application No. 60/878,966, filed on Jan. 5, 2007.

(51) Int. Cl. B42D 15/00

(52) U.S. Cl. 283/81

(57) ABSTRACT

A multi-layer construct is provided for simultaneously displaying old and new product information. The construct includes a liner that has removable and permanent portions. A removable adhesive is applied to a front surface of the first portion of the liner and a permanent adhesive is applied to a front surface of the second portion of the liner. A transparent film is secured to the removable adhesive and a printable label is secured to the permanent adhesive. The first portion of the liner can be separated from remainder of the construct so that the transparent film can be applied removably over the old product information. The new product information can be printed on the printable label.

This application claims priority on U.S. Provisional Patent Appl. No. 60/789,195, filed Apr. 3, 2006 and U.S. Provisional Patent Appl. No. 60/878,966, filed Jan. 5, 2007.

### BACKGROUND OF THE INVENTION

1. Field of the Invention

This invention relates to a multi-layer sheet useful for marking special sales or promotions on the edge of a shelf in a retain store.

2. Description of the Related Art

Retail stores, such as drug stores and food markets have arrays of shelves for displaying products offered for sale. Pricing information generally is presented on the front edge of the shelf in front of the items that are being displayed for sale.

Retail stores or the manufacturers of products frequently offer promotions on selected items. The promotion often is a reduction in price. However, other promotions are common, such as “Buy One Get One Free” or “Buy One Get the Second at Half Price”. The promotional offering can simply be placed over the original pricing label appearing on the shelf in the retail facility. However, the promotional offering generally exists for only a limited time. As a result, a retail store generally would not want to discard or destroy the original pricing label. In this regard, a retail store devotes considerable time and money to ensure that the shelves for all products are properly marked. A promotional program that required remarking the shelves at the end of the promotion would be time consuming and costly.

Labels can be printed with a removable adhesive. A label with a removable adhesive could be imprinted with the promotional offer and could be applied over the original edge of shelf pricing label. The retail store operator then could simply remove the label with the promotional offering at the end of the promotion. The existing pricing label then would remain on the shelf to advise the consumer of the standard price for the objects on the shelf. However, a consumer might appreciate the value of the offer if the consumer knew the original price and could compare the original price to the promotional offering. The promotional offering could be placed near the original label so that the consumer could observe both the original price and the promotional offering. However, most retail stores try to keep a neat and orderly appearance for their shelves. The use of side-by-side pricing label creates a disorderly appearance. Furthermore, many products are allotted only a small area of shelf space. As a result, the side-by-side presentation of pricing information could create confusion among the purchasing public. In particular, a consumer might not fully appreciate which promotional offering corresponded to which product or which promotional price label corresponded to which original price label.

Many pricing labels are prepared as multi-layer structures. The multilayer structures include a top sheet that will be imprinted with appropriate information for identifying a product and its price. This label will be releasably secured to a release liner. The top sheet and the release liner remain secured to one another during printing of the information on the top sheet and during storage after printing. The release liner is removed prior to use so that the top sheet can be secured to a substrate. Multi-layer label structures must be of substantially uniform thickness to ensure reliable jam-free processing through a printer. Thus, each of the two opposite surfaces of a multi-layer label construction should be substantially planar across the extent of the surface. Non-planar regions or other surface discontinuities can cause a printer to jam and can cause an unintended separation of the top sheet from the release liner.

The subject invention was made in view of the above-described state-of-the-art, and an object of the invention is to provide a multi-layer construct for efficiently presenting promotional information on the edge of a retail shelf.

### SUMMARY OF THE INVENTION

The invention relates to a multi-layer construct for presenting pricing or other promotional information on the edge of a shelf in a retail store. In particular, the construct is intended to present information that is likely to be relevant and accurate for only a limited promotional period. Additionally, the construct is uniquely designed to permit a continued display of original pricing information on the edge of the retail shelf and to avoid destruction of the original pricing information.

The multi-layer construct of the subject invention includes a liner having opposite front and rear surfaces. The front surface of the liner includes an alternating array of permanent adhesive and removable adhesive. The removable adhesive preferably is substantially transparent. Areas of the front surface of the liner to which the removable adhesive will be applied may be coated initially with a thin layer of a release coating, such as silicone, to ensure that the removable adhesive is removable easily from the liner.

The multi-layer construct of the subject invention further includes a front layer with opposite front and rear surfaces. The rear surface of the front layer is secured to the adhesive on the front surface of the liner. Portions of the front layer that align with the removable adhesive preferably are formed from a plastic sheet material. The plastic sheet material preferably is transparent, but may be an opaque material that substantially conforms to the color of an existing pricing label (e.g., white) or to the color of an existing shelf edge. Portions of the front layer that align with the permanent adhesive on the liner may be formed from a non-transparent material that is well suited to receiving printed indicia. For example, portions of the front layer that align with the permanent adhesive on the liner may be formed from paper. The two different materials that comprise the front layer of the multi-layer construct have thicknesses to ensure a uniform thickness for the multi-layer construct and to ensure a substantially planar front surface for the multi-layer construct. As a result, the construct can be processed efficiently through a printing apparatus. Additionally, the two materials that comprise the front layer of the multi-layer construct preferably are permanently secured in edge-to-edge relationship to ensure that the two different materials that comprise the front layer are not separated from one another during printing, storage or use.

In certain embodiments, a radio frequency identification device (RFID) may be secured as an inlay between portions of the front layer that are secured permanently to the liner. The RFID inlay enables additional information to be conveyed to employees or management personnel, such as inventory and pricing data. For example, the RFID inlay may signal store personnel at the end of a promotional program so that the multi-layer construct can be removed from a display in a timely manner.

The liner preferably includes perforations, die cuts or the like at locations that align with the boundaries between the removable and permanent adhesive. As a result, the portion of the liner that aligns with the removable adhesive can be separated from the multi-layer construct to expose the removable adhesive. However, the portion of the liner that aligns with the permanent adhesive will remain permanently adhered to corresponding parts of the front layer.

The multi-layer construct is employed by separating the portion of the liner from the removable adhesive to expose the removable adhesive. The multi-layer construct then is applied directly over the shelf edge pricing label in a retail store. The portion of the front layer registered with the removable adhesive preferably is formed from a transparent plastic material and the removable adhesive preferably is substantially transparent. Hence, the original label is visible through the transparent part of the front layer. In these embodiments, printing is not required on the transparent plastic material. In other embodiments, the plastic part of the front layer may be opaque (e.g., white) and indicia, such as the original price, may be printed on the opaque plastic. This embodiment gives the customer a very clean clear indication of the original price. The area of the multi-layer construct that is permanently secured to the liner will be suspended from the shelf directly beneath the original shelf edge pricing label. As a result, promotional information printed on the front surface of the front layer will be suspended directly beneath the original pricing label. A consumer will notice the promotional price and the original price visible through the transparent film of the multi-layer construct or printed on an opaque plastic film of the multi-layer construct. The multi-layer construct can be separated from the shelf and from the original label at the end of the promotional term. The removable adhesive will not damage the original label, and hence relabeling the original price is not necessary.

The multi-layer constructs of the subject invention preferably are manufactured in strip or sheet form with a plurality of such constructs connected to one another in end-to-end and/or side-to-side relationship. Perforations or die cuts are provided entirely through adjacent multi-layer constructs so that the constructs can be separated from one another. However, a plurality of such constructs can be processed quickly through an automated printing apparatus to achieve processing efficiencies and to avoid separate printing of the promotional multi-layer constructs. The printing can be performed at a central location and the printed constructs can be distributed to the stores in a ready to use form. Alternatively, the constructs can be distributed in an unprinted form or a partly printed form to the stores. The stores then can print appropriate indicia onto portions of the front layer of the constructs.

### BRIEF DESCRIPTION OF THE DRAWINGS

FIG. 1 is a front elevational view of a retail store shelf with a shelf edge pricing label applied thereto.

FIG. 2 is a top plan view of a multi-layer label construct in accordance with the subject invention.

FIG. 3 is a side elevational view of the multi-layer construct of FIG. 2.

FIG. 4 is a bottom plan view of the multi-layer label construct of the subject invention.

FIG. 5 is a front elevational view of the multi-layer label construct of the subject invention applied to the retail shelf of FIG. 1.

FIG. 6 is a cross-sectional view taken along line 6-6 in FIG. 5.

FIG. 7 is flow diagram showing a method of using the multi-layer construct.

FIG. 8 is a top plan view similar to FIG. 2, but showing an alternate embodiment of the multi-layer construct.

### DETAILED DESCRIPTION OF THE PREFERRED EMBODIMENT

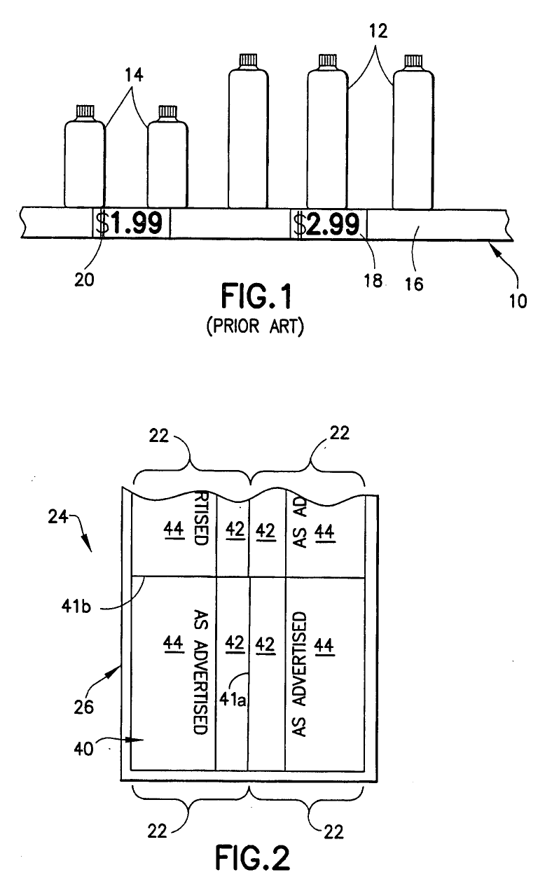

The prior art retail shelf is identified generally by the numeral 10 in FIG. 1. The shelf 10 extends substantially horizontally and supports a plurality of different types of products 12 and 14.

The shelf 10 includes a front edge 16 that is configured to accommodate pricing labels 18 and 20 corresponding respectively to the products 12 and 14. Promotions of limited time duration periodically will be offered for certain of the products 12 or 14. The promotion typically will include a price reduction, but may include other promotional offers as well.

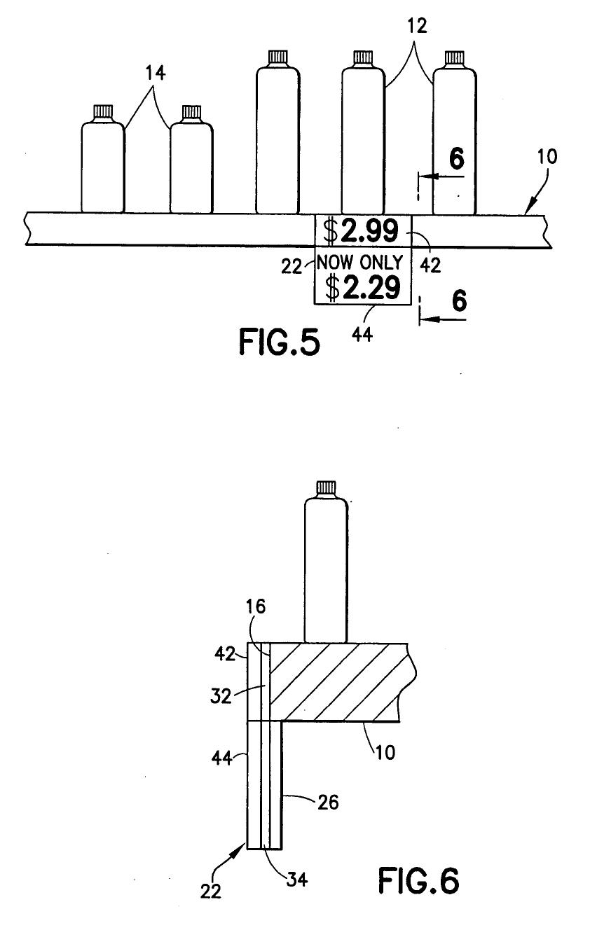

A multi-layer label construct to present the promotional pricing information is identified generally by the numeral 22 in FIGS. 2-6. A plurality of such multi-layer constructs 22 typically will be secured in end-to-end and side-to-side relationship with one another to define a strip-shaped or sheet-shaped array 24 that can be processed through an automated printing apparatus. However, the multi-layer constructs 22 can be separated from one another for use on the prior art shelf 10, as described herein.

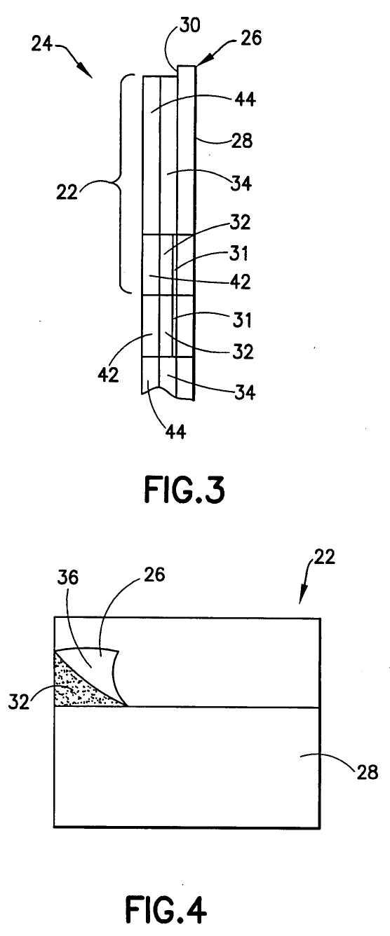

As shown most clearly in FIG. 3, the array 24 of multi-layer constructs 22 includes a liner 26 with opposite back and front faces 28 and 30. The liner 26 may be formed from paper or a synthetic sheet material, but should be a high performance lay-flat liner specifically engineered for both high speed and low speed printers. Additionally, the liner 26 should have no more than ⅛ inch curl through the entire process to ensure performance at both the print shop and at the store. One preferred liner 26 is a 70# basis paper with good holdout properties conducive to silicone coating.

A thin release coating of silicone 31 is applied directly to a selected area on the front face 30. A removable adhesive 32 is applied over the silicone 31 and a permanent adhesive 34 is applied to parts of the front face 30 of the liner 26 that have no silicone 31. The silicone 31 facilitates separation of the liner 26 from the removable adhesive 32, as explained further herein. In this regard, the release force to separate the liner 36 and silicone 31 from the removable adhesive 32 preferably is about 5-10 gms (grams per meter squared). The removable adhesive 32 is selected to achieve short term removablility, excellent die-cutting characteristics and excellent stripping characteristics. More particularly, the peel force of the removable adhesive 32 should be sufficient to hold the multi-layer construct 22 on the existing pricing label 18, 20 without removing the existing pricing label 18, 20 from the front edge 16 of the shelf 10 and without removing the toner on the existing pricing label 18, 20. Additionally, the removable adhesive 32 preferably is transparent. A preferred removable adhesive 32 is a hot melt removable rubber-based adhesive, such as the HB Fuller Company 2643 adhesive.

The permanent adhesive 34 is a permanent pressure sensitive adhesive designed to perform in industrial-like applications without compromising digital imaging processing. Additionally, the permanent adhesive 34 should have excellent “quick stick” and permanence to practically all commonly labeled surfaces, such as, most papers, metals, painted surfaces, polyolefins, hard plastics and uncoated cardboard. A preferred removable adhesive is a hot melt rubber-based adhesive, such as the HB Fuller Company 2091 adhesive. Although both the HB Fuller Company 2643 adhesive and the HB Fuller Company 2091 adhesive have worked well, other brands of adhesive can be used.

Both the removable adhesive 32 and the permanent adhesive 34 preferably are applied to provide a narrow boundary (e.g. 1/16 inch) around the periphery of the liner 26 to assure contamination free processing in high and low volume digital imaging applications. A process for applying adhesive in this manner is marketed by Avery Dennison under the trademark Xonad.

Die cuts or perforation arrays preferably are formed through the liner 26 at locations that register with the demarcations between the areas of removable adhesive 32 and the areas of permanent adhesive 34.

Each multi-layer construct 22 further includes a front layer 40 applied over the adhesive 32, 34 on the front surface of the liner 26. Portions of the front layer 40 that align with the removable adhesive 32 are formed from a plastic film 42, such as films designed for desktop and low speed printers. The film 42 preferably is transparent. More particularly, the film 42 and the removable adhesive 32 should be sufficiently clear to ensure that the existing pricing label 18, 20 is human readable and barcode scannable. A preferred transparent film 42 is a clear polyester with a thickness of about 2.0-3.0 mils. However, other clear or white filmic materials can be used. The transparent film 42, the removable adhesive 32, the silicone 31 and the liner 26 are selected and processed to permit the film 42 and the removable adhesive 32 to be separated from the silicone 31 with a release force of 5-10 gms (grams per meter squared). However, an opaque film can be employed in a situation where the film 42 remains with the shelf 16 upon completion of the sale period. Die cuts or perforations located at or near sections 44 and 42 would facilitate separation of the film 42 from the remainder of the construct 22.

Portions of the front layer 40 that align with the permanent adhesive 34 are formed from printable labeling material 44 with a thickness approximately the same as the transparent film 42 to ensure efficient processing by the printer. The printable labeling material 44 preferably is a machine grade coated base paper, and for simplicity will be referred to herein as paper 44. However, it should be understood that printable labeling materials other than paper can be employed in some situations. Areas of the paper 44 that are to be printed may be coated with an aqueous styrene acrylic base toner enhancement treatment, such as the treatment available from Water Ink Technology.

The film 42 and the paper 44 of each multi-layer construct 22 are permanently secured in edge-to-edge relationship at an abutting edge region 46. As a result, the film 42 and the paper 44 of each multi-layer construct 22 will remain attached to one another during printing and during use. However, the film 42 and paper 44 of one multi-layer construct 22 are not secured permanently in edge-to-edge relationship to the film 42 and/or the paper 44 of the adjacent multi-layer construct layer 22. Rather, arrays 41a, 41b of spaced-apart die cuts or perforations extend through the liner 26 and the front layer 40 between multi-layer constructs 22, as shown in FIG. 2. The spacing between the die cuts and the length of the die cuts enable an array 24 of multi-layer constructs 22 to be processed through a printing apparatus. However, adjacent multi-layer constructs 22 of the array 24 can be separated from one another cleanly along the die cut or perforation arrays 41a, 41b through the liner 26 and the front layer 40. In the embodiment of FIG. 2, all of the illustrated films 42 initially are unitary, but are made cleanly severable by the die cuts 41a, 41b. The printable paper labels 44 on the right side of FIG. 2 initially are a unitary strip and the printable paper labels 44 on the left side of FIG. 2 also initially are unitary. However, the printable paper labels 44 of adjacent multilayer constructs 22 can be separated along the die cut arrays 41b.

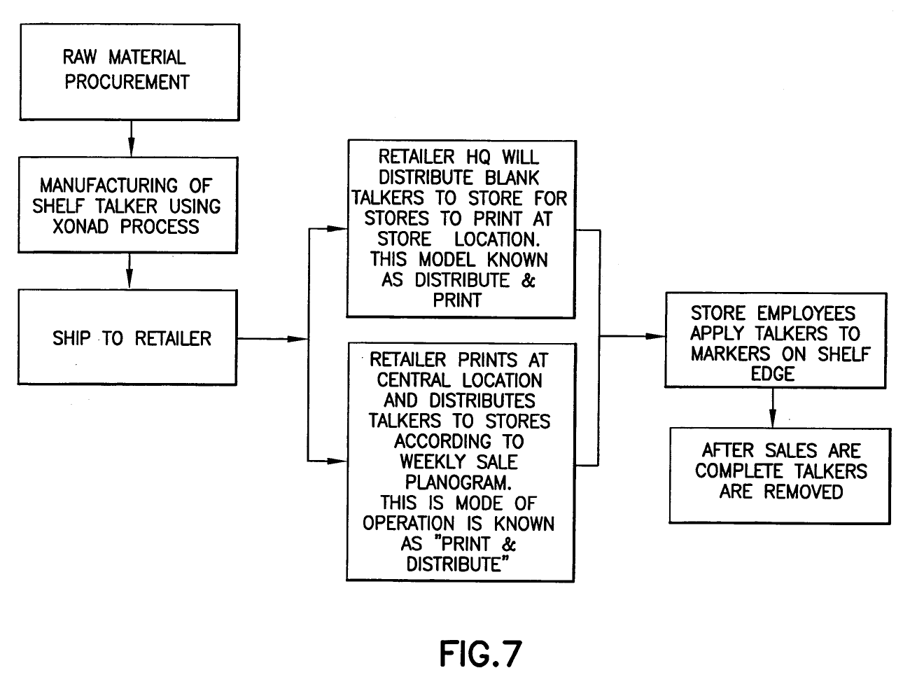

The array 24 of constructs 22 can be processed through an automated printing apparatus, as shown in FIG. 7, so that promotional pricing information and other promotional data may be printed on the front face 48 of the paper 44 of each multi-layer construct 22. The printing on the front face 48 of the paper 44 can be carried out at a central location for a chain of retail stores, and the printed arrays 24 of constructs 22 can then be shipped to individual stores. Alternatively, all or part of the printing may be carried out at the individual stores. These, two optional processes are shown in the flow diagram of FIG. 7. The preprinting that may be applied at a central location for a chain of retail stores is shown, for example by the imprinted indicia reading “AS ADVERTISED” in FIG. 2 and the printed indicia reading “NOW ONLY” in FIG. 5. The printing carried out at the local retail facility may be the specific price, such as the “$2.29” shown in FIG. 5. After printing, the multi-layer constructs 22 of the array 24 can be separated from one another. The portion of the liner 26 that aligns with the removable adhesive 32 and the film 42 can be separated from the portion of the liner 26 that aligns with the permanent adhesive 34 and the paper 44. The removable adhesive 32 remains attached to the rear face of the film 42 partly due to the application of silicone 31 locally to the front surface 30 of the liner 26. The removable adhesive 32 then is applied over the label 18, 20 on the front edge 16 of the shelf 10. The original price presented on the label 18, 20 remains visible through the transparent film 42 and the transparent removable adhesive 32. As a result, a consumer can readily observe the original purchase price. However, the indicia imprinted on the front face 48 of the paper 44 presents the promotional price and perhaps other promotional information to draw the attention of the consumer. As a result, the consumer can readily compare the original price on the permanent label 18, 20 to the promotional price on the paper 44 of the multi-layer construct 22. At the end of the promotional term, the retail store operator simply can separate the construct 32 from the permanent label 18, 20 by applying a pulling force on the paper 44 and the liner 34. The removable adhesive 32 will readily separate from permanent label 18, 20, and no relabeling is required. More particularly, the peel force of the removable adhesive 32 should be sufficient to hold the multi-layer construct 22 on the existing pricing label 18, 20 without removing the existing pricing label 18, 20 from the front edge 16 of the shelf 10 and without removing the toner on the existing pricing label 18, 20.

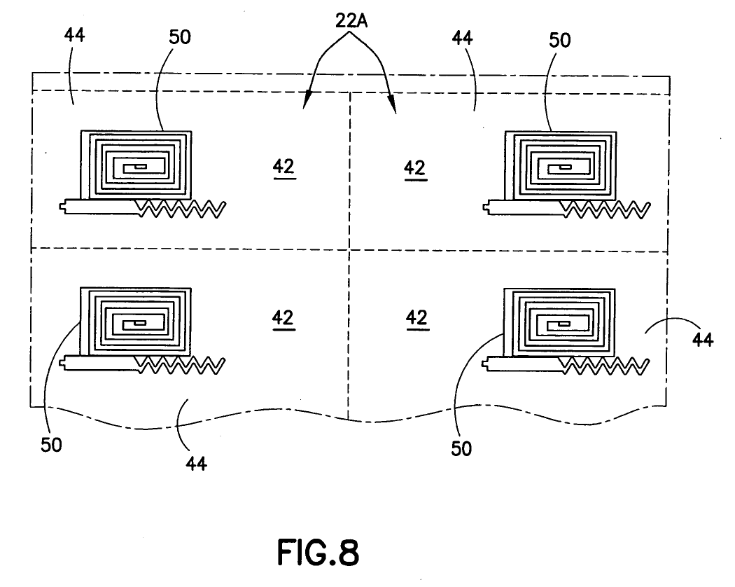

An alternate construct is illustrated in FIG. 8 and is identified generally by the numeral 22A. The construct 22A is substantially the same as the construct 20 described above and illustrated in FIGS. 1-6. However, a radio frequency identification device (RFID) 50 is laminated permanently as an inlay between the liner 26 and the paper 44. The RFID inlay 50 is selected to permit processing of the construct 22A through a digital imaging apparatus. The construct 22A is made and used like the construct 22. However, the construct 22A has the additional advantage of being able to transmit data to store personnel relating to the product inventory covered by a special offer or to terms of a special offer. The RFID inlay 50 can perform any of the functions of a label bar code as well as many additional functions.

While the invention has been described with respect to preferred embodiments, it is apparent that various changes can be made without departing from the invention defined by the appended claims. For example, the film 42 may be formed from a substantially opaque material (e.g., white plastic) that preferably corresponds to the color of the existing label 18 or 20 or the color of the shelf 16. The existing price then may be printed on the opaque film 42 to ensure that all pricing information presented to the consumer during the promotional period is clear and clean.

What is claimed is:

1. A multi-layer construct for presenting old and new product information, comprising a liner having at least one removable part, at least one permanent part and a front face extending across the entire liner, a removable adhesive removably disposed across portions of the front face of the liner corresponding to the removable part, and permanent adhesive disposed on portions of the front face of the liner corresponding to the permanent part, a film secured to the removable adhesive and releasably attached to the removable part of the liner and a printable label substantially permanently secured on the permanent part of the liner by the permanent adhesive, whereby the removable part of the liner can be separated from remaining parts of the construct so that the removable adhesive can removably secure the film over the old product information and so that the printable label can present the new product information.

2. The multi-layer construct of claim 1, wherein the film and the printable label have substantially equal thicknesses.

3. The multi-layer construct of claim 1, wherein the construct is of substantially uniform thickness at all locations thereon.

4. The multi-layer construct of claim 1, wherein the printable label is formed from paper.

5. The multi-layer construct of claim 1, wherein the film and the removable adhesive are substantially transparent.

6. The multi-layer construct of claim 1, further comprising a release coating between the front face of the removable part of the liner and the removable adhesive.

7. The multi-layer construct of claim 1, wherein the liner includes a cut line between the removable part and the permanent part of the liner to facilitate separation of the removable part from the construct.

8. The multi-layer construct of claim 7, wherein the film and the printable label are secured in edge-to-edge contact.

9. The multi-layer construct of claim 1, wherein the at least one removable part of the liner comprises at least first and second removable parts and wherein the at least one permanent part of the liner comprises at least first and second permanent parts.

10. The multi-layer construct of claim 9, wherein the first and second removable parts of the liner are substantially adjacent one another.

11. The multi-layer construct of claim 1, further comprising an RFID inlay between the liner and the printable label.

12. A multi-layer construct for simultaneously presenting old and new product information, the construct comprising:
a liner having opposite front and rear faces and at least one cut line extending at least partly through the liner from the front face to the rear face for dividing the liner into at least one removable part and at least one permanent part;
a release coating applied to portions of the front face corresponding to the removable part of the liner;
a removable adhesive removably disposed on the release coating;
a substantially transparent permanent adhesive disposed on portions of the front face of the liner corresponding to the permanent part;
a substantially transparent film secured to the removable adhesive and releasably attached to the removable part of the liner; and
a printable paper label substantially permanently secured on the permanent part of the liner by the permanent adhesive and in edge-to-edge relationship with the transparent film, whereby the removable part of the liner can be separated from remaining parts of the construct so that the removable adhesive can removably secure the transparent film over the old product information and so that the printable label can present the new product information.

13. The multi-layer construct of claim 12, wherein the transparent film and the printable label have substantially equal thicknesses.

14. The multi-layer construct of claim 12, wherein the construct is of substantially uniform thickness at all locations thereon.

15. The multi-layer construct of claim 12, further comprising arrays of spaced apart die cuts extending through the liner and through corresponding areas of the transparent film and the printable paper label, the die cuts being dimensioned and spaced from one another for permitting the multi-layer construct to be processed through a printer, and for permitting separation of the multi-layer construct along the die cuts for defining a plurality of the constructs.

16. A method for presenting temporary pricing information on a retail shelf, comprising:
providing a multi-layer construct having a transparent film with front and rear surfaces, a non-transparent printable label with front and rear surfaces and disposed in edge-to-edge relationship with the transparent film, a removable adhesive on the rear surface of the transparent film and a permanent adhesive on the rear surface of the printable label and liners attached respectively to the removable and permanent adhesive;
printing temporary pricing information on the front surface of the printable label;
removing the liner from the removable adhesive;
removably securing the rear surface of the transparent film over an existing pricing label on an edge of the retail shelf so that the printable label is suspended from the shelf with the existing pricing label and the temporary pricing information visible simultaneously; and
removing the multi-layer construct from the existing pricing label at the end of a term for the temporary pricing.

17. The method of claim 16, wherein at least a portion of the printing is carried out at a location remote from a retail facility that has the shelf.

18. The method of claim 17, wherein a portion of the printing is carried out at the retail facility.
